(19) United States
(12) Patent Application Publication
(10) Pub. No.: US 2021/0371088 A1
(43) Pub. Date: Dec. 2, 2021

(54) LEADING EDGE STRUCTURE FOR A FLOW CONTROL SYSTEM OF AN AIRCRAFT

(71) Applicant: Airbus Operations GmbH, HAMBURG (DE)

(72) Inventors: Michael HÖFT, HAMBURG (DE); Frank NIELSEN, HAMBURG (DE)

(21) Appl. No.: 17/185,394

(22) Filed: Feb. 25, 2021

(30) Foreign Application Priority Data
Feb. 27, 2020 (DE) 102020105194.8

(51) Int. Cl. B64C 21/02; B64C 5/06

(52) U.S. Cl. CPC B64C 21/025; B64C 5/06

(57) ABSTRACT

A leading edge structure for an aircraft flow control system includes a leading edge panel curvingly surrounding a plenum. The leading edge panel has a first side portion and a second side portion with an inner surface facing the plenum and an outer surface contacting an ambient flow. The leading edge panel includes a plurality of micro pores forming a fluid connection between the plenum and the ambient flow. An air outlet is arranged in the first or second side portion and is fluidly connected to the plenum for letting out air from the plenum into the ambient flow. The air outlet is formed as a fixed air outlet including an outlet panel extending in a fixed manner from the leading edge panel into the ambient flow, such that a rearward facing outlet opening is formed between the leading edge panel and a rear edge of the outlet panel.

### CROSS-REFERENCES TO RELATED APPLICATIONS

This application claims the benefit of the German patent application No. 102020105194.8 filed on Feb. 27, 2020, the entire disclosures of which are incorporated herein by way of reference.

### FIELD OF THE INVENTION

The present invention relates to a leading edge structure for a flow control system of an aircraft, in particular for a Hybrid Laminar Flow Control system, where air is sucked in a porous surface of a flow body in order to extend the region of laminar flow along the flow body. Further aspects of the present invention relate to a system of a control unit and such a leading edge structure, a vertical tail plane (VTP) comprising such a leading edge structure or such a system, an aircraft comprising such a leading edge structure, such a system or such a vertical tail plane, and a method for operating such a leading edge structure. It might also be possible and preferred that the leading edge structure is part of a horizontal tail plane (HTP) or of a wing for an aircraft.

### BACKGROUND OF THE INVENTION

The leading edge structure comprises a leading edge panel that surrounds a plenum in a curved, i.e., arcuate, manner. The plenum extends in a span direction through the leading edge structure.

When viewed in a cross section across the span direction, the leading edge panel has a first side portion extending from a leading edge point, i.e., from a fore tip of the leading edge structure, to a first attachment end on a first side of the leading edge structure, the first attachment end being configured for attachment to a further structure located downstream from the leading edge. Further, the leading edge panel has a second side portion opposite the first side portion, wherein the second side portion extends from the leading edge point to a second attachment end on a second side of the leading edge structure opposite the first side, the second attachment end being configured for attachment to a further structure downstream from the leading edge.

The leading edge panel comprises an inner surface facing the plenum and an outer surface in contact or configured to be in contact with an ambient flow. Further, the leading edge panel comprises a plurality of micro pores, such as perforations, forming a fluid connection between the plenum and the ambient flow, so that air from the ambient flow can be sucked in through the micro pores into the plenum.

Further, an air outlet is arranged in the first side portion or in the second side portion of the leading edge panel. The air outlet is configured for discharging air from the plenum into the ambient air flow, thereby creating an underpressure in the plenum, so that air from the ambient flow, in particular from the boundary layer, is sucked through the micro pores into the plenum. The leading edge panel might be formed integrally or might be formed separated by two or more separate panel parts arranged next to each other in the span direction, wherein a first panel part includes the micro pores and a second panel part includes the air outlet. The air outlet is fluidly connected to the plenum, preferably via a duct, for letting out air from the plenum into the ambient flow.

Such leading edge structures are known in the art of hybrid laminar flow control systems. In particular, it is known to arrange a first air inlet/outlet device in a first side of a VTP of an aircraft and to arrange a second air inlet/outlet device in a second side of the vertical tail plane. Each air inlet/outlet device comprises two doors, one inlet door opening to the front for letting in air from the ambient flow to purge the pores, and one outlet door opening to the rear for letting out air into the ambient flow to cause suction at the pores. Such air inlet/outlet devices with movable doors and both inlet and outlet functionality, are complex devices requiring a plurality of different parts and complicated sealing, thereby increasing costs and weight of a related aircraft.

Therefore, an object of the present invention is to provide a simplified, more efficient leading edge structure.

### SUMMARY OF THE INVENTION

This object is achieved in that the air outlet is formed as a fixed air outlet comprising an outlet panel extending in a fixed, not movable manner from the leading edge panel rearwards, i.e., in a downstream direction, into the ambient flow, i.e., outside the outer mold line, such that a rearward facing outlet opening is formed between the leading edge panel and a rear edge of the outlet panel, for air from the plenum to be let out into the ambient flow. Preferably, the leading edge structure comprises only the air outlet but no air inlet, wherein cleaning of the micro pores is done by suction only. The air outlet might have opposite side walls connecting the opposite lateral sides of the outlet panel with the leading edge panel, such that the outlet opening is formed between the rear edges of the side walls, the rear edge of the outlet panel, and the leading edge panel.

By such a design of the leading edge structure movable parts, actuators and complicated sealing can be avoided, thereby largely simplifying the leading edge structure and reducing parts, thus reducing costs and weight.

According to a preferred embodiment, the leading edge structure further comprises an outlet valve for controlling the mass flow rate of air let out through the air outlet into the ambient flow. The outlet valve might be, e.g., an electrically or mechanically powered throttle valve, preferably including an air filter for filtering contaminants from the air before passing the valve. In particular, it is preferred that the outlet valve is arranged in a duct fluidly connecting the plenum to the air outlet. By such a valve, the mass flow rate of air passing through the air outlet and thus the mass flow rate of air sucked in from the ambient flow through the micro pores, can be controlled without requiring a movable outlet door or related actuator, thereby simplifying the leading edge structure without suffering loss of performance.

It is further preferred that the valve is configured for being controlled to selectively operate at least in a flow control mode and in a cleaning mode. In the flow control mode the valve allows a first mass flow rate to pass that is adapted for enabling a predetermined flow control at the outer surface of the leading edge panel, i.e., for generating a predetermined boundary layer suction through the micro pores into the plenum. In the cleaning mode the valve allows a second mass flow rate to pass that is adapted for cleaning the micro pores by suction from liquid, ice or dirt, i.e., for sucking liquid, ice or dirt from the micro pores into the plenum. In such a way, cleaning of the micro pores can be carried out by suction only, while no blowing of air from the plenum out through the micro pores is required for cleaning the micro pores. This, in turn, means that no air inlet is required for cleaning of the micro pores, thereby further simplifying the leading edge structure.

It is preferred that the second mass flow rate is greater than the first mass flow rate, preferably between 100% and 2000% greater, more preferably between 400% and 1000% greater, most preferably between 500% and 800% greater. Preferably, the second mass flow rate relates to a pressure differential of at least 5 kPa between the outer surface and the inner surface of the leading edge panel. In such a way, efficient cleaning can be carried out without essential changes to the duct form and dimensions.

According to a preferred embodiment, the micro pores are arranged only in a leading edge area of the leading edge panel. Preferably, the leading edge area extends from the leading edge point downstream until between 10% and 70%, preferably between 20% and 50%, more preferably between 30% and 40%, of the full chord extension of the leading edge panel, measured preferably at a root end, i.e., inbound end, of the leading edge panel. In such a way, the micro pores arranged only in those areas of the leading edge panel where the external pressure on the micro pores is such high that cleaning by suction is possible and advantageous, while the micro pores are omitted in those areas downstream from the leading edge area where the external pressure on the micro pores is so low that cleaning by suction would not be reasonably possible and only cleaning by blowing would be possible. However, to avoid having to clean the micro pores by blowing, in order to omit the related parts and thus simplify the leading edge structure, any micro pores downstream from the leading edge area are entirely omitted. The loss in flow control performance due to the omittance of these micro pores downstream from the leading edge area is compensated by the major benefits of the related simplification of the leading edge structure.

According to another preferred embodiment, the leading edge panel comprises first and second panel parts arranged next to each other in the span direction, wherein the first panel part includes the micro pores and the second panel part includes the first and second air inlet/outlet devices. The first and second panel parts are formed either integrally as one common part or separately as two separate parts that can be mounted together or mounted next to each other. In such a way, the micro pores and the first and second air inlet/outlet devices do not need to be arranged at the same span level of the leading edge panel or in the same panel part, but can be arranged in subsequent parts of the leading edge panel with respect to the span direction.

A further aspect of the present invention relates to a system of a control unit and a leading edge structure according to any of the embodiments described above. The control unit is configured, in particular programmed, for controlling the valve to selectively operate at least in a flow control mode and in a cleaning mode. In the flow control mode the valve allows a first mass flow rate to pass that is adapted for enabling a predetermined flow control at the outer surface of the leading edge panel, i.e., for generating a predetermined boundary layer suction through the micro pores into the plenum. In the cleaning mode the valve allows a second mass flow rate to pass that is adapted for cleaning the micro pores by suction from liquid, ice or dirt, i.e., for sucking liquid, ice or dirt from the micro pores into the plenum. The control unit might also be configured for controlling the valve to operate in several different flow control modes and/or in several different cleaning modes, relating to several different mass flow rates allowed to pass by the valve. The features and advantageous described in connection with the leading edge structure apply vis-à-vis to the system.

A further aspect of the present invention relates to a vertical tail plane for an aircraft. The vertical tail plane comprises a vertical tail plane box including a front spar, and a leading edge structure or a system according to any of the embodiments described herein. The vertical tail plane box has a first lateral panel with a first attachment portion and an opposite second lateral panel with a second attachment portion. First and second lateral panels are preferably mounted to the front spar. The first attachment end of the leading edge structure is attached to the first attachment portion and the second attachment end is attached to the second attachment portion, so that the first side portion of the leading edge panel forms a continuous flow surface with the first lateral panel of the vertical tail plane box and the second side portion of the leading edge panel forms a continuous flow surface with the second lateral panel of the vertical tail plane box. The features and advantageous described in connection with the leading edge structure and the system apply vis-à-vis to the vertical tail plane.

According to a preferred embodiment, the first and second panel parts are arranged at the vertical tail plane box next to each other in the span direction such that preferably the first panel part is arranged further outbound and the second panel part is arranged further inbound, i.e. closer to a root of the vertical tail plane, i.e. closer to a fuselage. In such a way, the ambient air flow passing the micro pores is independent from the ambient air flow passing the first and second inlet/outlet devices.

A further aspect of the present invention relates to an aircraft comprising a leading edge structure according to any of the embodiments described herein, comprising a system according to any of the embodiments described herein, or comprising a vertical tail plane according to any of the embodiment described herein. The features and advantageous described in connection with the leading edge structure, with the system and with the vertical tail plane apply vis-à-vis to the aircraft.

A further aspect of the present invention relates to a method for operating the leading edge structure according to any of the embodiments described above, wherein the valve is controlled, preferably by a control unit, to selectively operate at least in a flow control mode and in a cleaning mode. In the flow control mode the valve allows a first mass flow rate to pass that is adapted for enabling a predetermined flow control at the outer surface of the leading edge panel, i.e., for generating a predetermined boundary layer suction through the micro pores into the plenum. In the cleaning mode the valve allows a second mass flow rate to pass that is adapted for cleaning the micro pores by suction from liquid, ice or dirt, i.e., for sucking liquid, ice or dirt from the micro pores into the plenum. The features and advantageous described above in connection with the leading edge structure, with the system, with the vertical tail plane and with the aircraft, apply vis-à-vis to the method.

### BRIEF DESCRIPTION OF THE DRAWINGS

Preferred embodiments of the present invention are described hereinafter in more detail by means of a drawing. The drawing shows in

FIG. 1 a perspective view of an aircraft according to the invention,

FIG. 2 a side view of a vertical tail plane according to the invention,

FIG. 3 a cross sectional view across the span direction in the area of a first panel part of a leading edge structure mounted to a vertical tail plane box, according to a first embodiment of the invention,

FIG. 4 a cross sectional view across the span direction in the area of a first panel part of a leading edge structure mounted to a vertical tail plane box, according to a first embodiment of the invention,

FIG. 5 a schematic cross sectional view across the span direction in the area of a second panel part of a leading edge structure according to the second embodiment of the invention, and

FIG. 6 a perspective view of the leading edge structure shown in FIG. 5 with a focus on the second panel part.

### DETAILED DESCRIPTION OF THE PREFERRED EMBODIMENTS

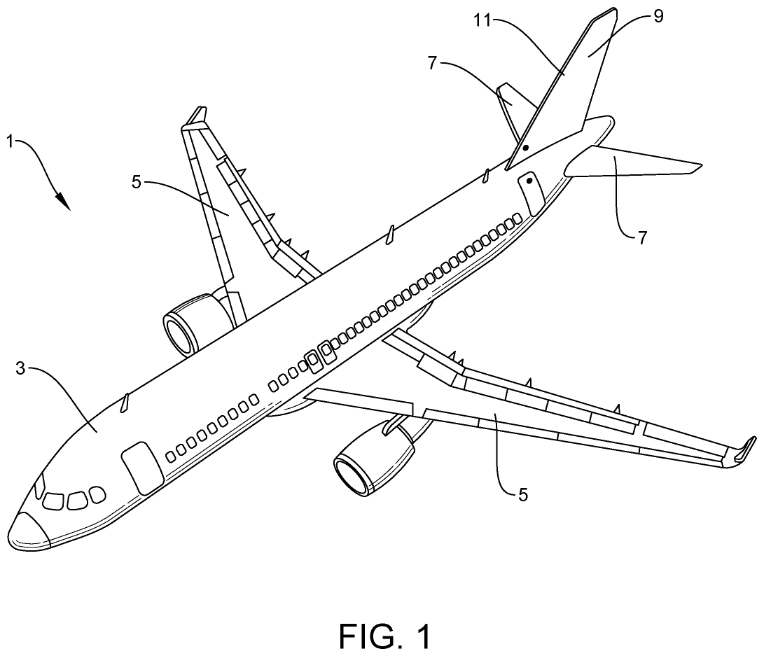

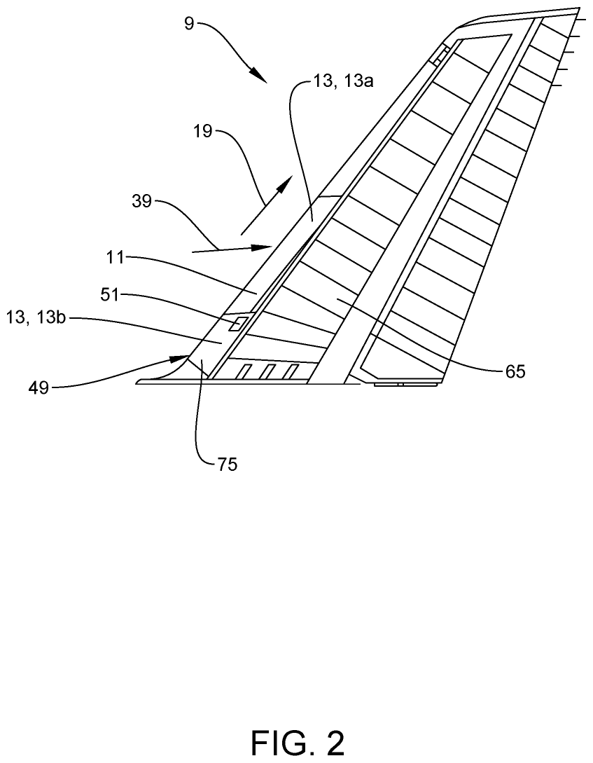

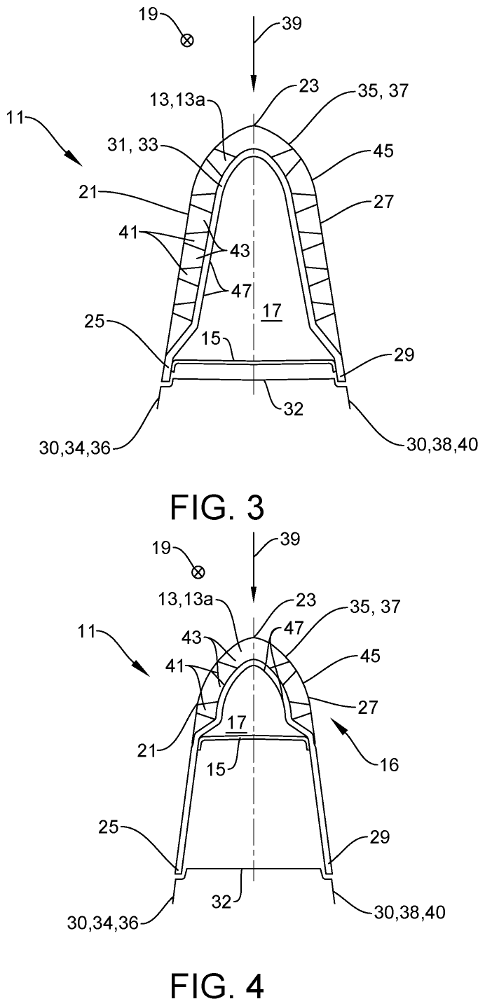

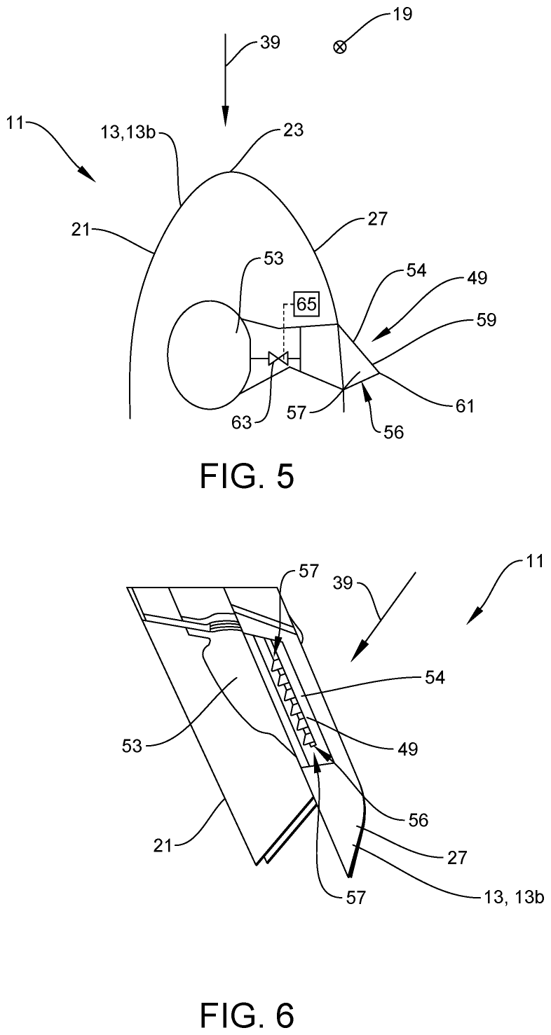

In FIG. 1 an aircraft 1 according to an embodiment of the present invention is shown. The aircraft comprises a fuselage 3, wings 5, a horizontal tail plane 7, and a vertical tail plane 9 according to an embodiment of the invention. The vertical tail plane 9 is shown in more detail in FIG. 2. The vertical tail plane 9 comprises a leading edge structure 11 according to an embodiment of the invention. Various embodiments of the leading edge structure 11 are shown in more detail in FIGS. 3 to 6, wherein FIGS. 3 and 4 show a cross section at a first span level in the area of a first panel part 13a while FIG. 5 shows a cross section and FIG. 6 shows a perspective view at a second span level in the area of a second panel part 13b.

As shown in FIGS. 2 to 4, the leading edge structure 11 is configured for hybrid laminar flow control and comprises a leading edge panel 13 comprising first and second panel parts 13a, 13b, and a back wall 15. The first and second panel parts 13a, 13b are formed separately as two separate parts and are mounted to the vertical tail plane 9 next to each other in the span direction 19, wherein the first panel part 13a is arranged further outbound and the second panel part 13b is arranged further inbound, see FIG. 2. The leading edge panel 13 surrounds a plenum 17 in a curved manner The plenum 17 extends in the span direction 19 through the leading edge structure 11. When viewed in a cross section across the span direction 19, the leading edge panel 13 has a first side portion 21 extending from a leading edge point 23 to a first attachment end 25 on a first side of the leading edge structure 11. Further, the leading edge panel 13 has a second side portion 27 opposite the first side portion 21, wherein the second side portion 27 extends from the leading edge point 23 to a second attachment end 29 on a second side of the leading edge structure 11 opposite the first side. The back wall 15 connects the first attachment end 25 to the second attachment end 29 of the leading edge panel 13, thereby enclosing the plenum 17 on a side opposite the leading edge point 23.

As also shown in FIGS. 2 to 4, the vertical tail plane 9 comprises a vertical tail plane box 30 including a front spar 32, and the leading edge structure 11 is mounted to the vertical tail plane box 30. The vertical tail plane box 30 has a first lateral panel 34 with a first attachment portion 36 and an opposite second lateral panel 38 with a second attachment portion 40. The first attachment end 25 of the leading edge structure 11 is attached to the first attachment portion 36 and the second attachment end 29 is attached to the second attachment portion 40, so that the first side portion 21 of the leading edge panel 13 forms a continuous flow surface with the first lateral panel 34 of the vertical tail plane box 30 and the second side portion 27 of the leading edge panel 13 forms a continuous flow surface with the second lateral panel 38 of the vertical tail plane box 30.

As also shown in FIGS. 3 and 4, the leading edge panel 13 has a double-walled form including an inner wall element 31 having an inner surface 33 facing the plenum 17, and an outer wall element 35 having an outer surface 37 in contact with an ambient flow 39. Between the inner and outer wall elements 31, 35 the leading edge panel 13 comprises a plurality of elongate stiffeners 41 extending in the span direction 19 and spaced apart from one another, so that between each pair of adjacent stiffeners 41 a hollow chamber 43 is formed between the inner and outer wall elements 31, 35. The stiffeners 41 are formed integrally with the inner wall element 31 in a sandwich form and have a solid, trapezoid-shaped cross section. The inner wall element 31 is formed of a fiber reinforced plastic (FRP). The outer wall element 35 is formed as a titanium sheet and comprises a plurality of micro pores 45 forming a fluid connection between the hollow chambers 43 and the ambient flow 39. The inner wall element 31 comprises openings 47 forming a fluid connection between the hollow chambers 43 and the plenum 17.

While in the embodiment shown in FIG. 3 the micro pores 45 and the double-walled sandwich construction of the leading edge panel 13 including stiffeners 41 and hollow chambers 43 is present essentially along the entire chord extension of the leading edge panel 13, in the embodiment shown in FIG. 4 the micro pores 45 and related sandwich construction are arranged only in a leading edge area 16 of the leading edge panel 13. In the areas of the leading edge panel 13 downstream from the leading edge area 16 the leading edge panel 13 is formed as a monolithic single wall structure. The leading edge area 16 in the embodiment of FIG. 4 extends from the leading edge point 23 downstream until about 35% of the full chord extension of the leading edge panel 13.

As shown in FIGS. 5 and 6, an air outlet 49 is arranged in the first side portion 21 or in the second side portion 27 of the leading edge panel 13. The air outlet 49 is configured for discharging air from the plenum 17 into the ambient flow 39. The air outlet 49 is fluidly connected to the plenum 17 via a duct 53 extending in the span direction 19 between the first and second panel parts 13a, 13b.

The air outlet 49 is formed as a fixed air outlet comprising an outlet panel 54 extending in a fixed manner from the leading edge panel 13 rearwards into the ambient flow 39 such that a rearward facing outlet opening 56 is formed between the leading edge panel 13 and a rear edge 61 of the outlet panel 54, for air from the plenum 17 to be let out into the ambient flow 39. The leading edge structure 11 comprises only one air outlet 49 but no air inlet, such that cleaning of the micro pores 45 is done by suction only. The air outlet 49 has opposite side walls 57 connecting the opposite lateral sides 59 of the outlet panel 54 with the leading edge panel 13, such that the outlet opening 56 is formed between the rear edges 62 of the side walls 57, the rear edge 61 of the outlet panel 54, and the leading edge panel 13.

The leading edge structure 11 further comprises an outlet valve 63 for controlling the mass flow rate of air let out through the air outlet 49 into the ambient flow 39. The outlet valve 63 is arranged in a duct 53 fluidly connecting the plenum 17 to the air outlet 49. The valve 63 is controlled by a control unit 65 provided in the aircraft 1, to selectively operate in a flow control mode and in a cleaning mode. In the flow control mode the valve 63 allows a first mass flow rate to pass that is adapted for enabling a predetermined flow control at the outer surface 37 of the leading edge panel 13, i.e., for generating a predetermined boundary layer suction through the micro pores 45 into the plenum 17. In the cleaning mode the valve 63 allows a second mass flow rate to pass that is adapted for cleaning the micro pores 45 by suction from liquid, ice or dirt, i.e., for sucking liquid, ice or dirt from the micro pores 45 into the plenum 17. In the present embodiment, the second mass flow rate is 700% greater than the first mass flow rate.

By such a design of the leading edge structure 11 movable parts, actuators and complicated sealing can be avoided, thereby largely simplifying the leading edge structure 11 and reducing parts, thus reducing costs and weight.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A leading edge structure for a flow control system of an aircraft, comprising:
a leading edge panel that surrounds a plenum in a curved manner, the plenum extending in a span direction,
wherein the leading edge panel has a first side portion extending from a leading edge point to a first attachment end,
wherein the leading edge panel has a second side portion opposite the first side portion, extending from the leading edge point to a second attachment end,
wherein the leading edge panel comprises an inner surface facing the plenum and an outer surface in contact with an ambient flow,
wherein the leading edge panel comprises a plurality of micro pores forming a fluid connection between the plenum and the ambient flow,
wherein an air outlet is arranged in the first side portion or in the second side portion of the leading edge panel,
wherein the air outlet is fluidly connected to the plenum to let out air from the plenum into the ambient flow, and
wherein the air outlet is formed as a fixed air outlet comprising an outlet panel extending in a fixed manner from the leading edge panel into the ambient flow, such that a rearward facing outlet opening is formed between the leading edge panel and a rear edge of the outlet panel.

2. The leading edge structure according to claim 1, further comprising an outlet valve for controlling a mass flow rate of air let out through the air outlet into the ambient flow.

3. The leading edge structure according to claim 2, wherein the outlet valve is arranged in a duct fluidly connecting the plenum to the air outlet.

4. The leading edge structure according to claim 2, wherein the outlet valve is configured to be controlled to selectively operate in a flow control mode, where the outlet valve allows a first mass flow rate to pass that is configured to enable a predetermined flow control at the outer surface of the leading edge panel, and in a cleaning mode, where the outlet valve allows a second mass flow rate to pass that is configured to clean the micro pores by suction.

5. The leading edge structure according to claim 4, wherein the second mass flow rate is greater than the first mass flow rate.

6. The leading edge structure according to claim 4, wherein the second mass flow rate is between 100% and 2000% greater than the first mass flow rate.

7. The leading edge structure according to claim 4, wherein the second mass flow rate is between 400% and 1000% greater than the first mass flow rate.

8. The leading edge structure according to claim 4, wherein the second mass flow rate is between 500% and 800% greater than the first mass flow rate.

9. The leading edge structure according to claim 1,
wherein the micro pores are arranged only in a leading edge area of the leading edge panel, and
wherein the leading edge area extends from the leading edge point downstream until between 10% and 70% of a full chord extension of the leading edge panel.

10. The leading edge structure according to claim 1,
wherein the micro pores are arranged only in a leading edge area of the leading edge panel, and
wherein the leading edge area extends from the leading edge point downstream until between 20% and 50%, of a full chord extension of the leading edge panel.

11. The leading edge structure according to claim 1,
wherein the micro pores are arranged only in a leading edge area of the leading edge panel, and
wherein the leading edge area extends from the leading edge point downstream until between 30% and 40% of a full chord extension of the leading edge panel.

12. The leading edge structure according to claim 1,
wherein the leading edge panel comprises first and second panel parts arranged next to each other in the span direction,
wherein the first panel part includes the micro pores and a second panel part includes first and second air inlet/outlet devices, and
wherein the first and second panel parts are formed integrally.

13. The leading edge structure according to claim 1,
wherein the leading edge panel comprises first and second panel parts arranged next to each other in the span direction,
wherein the first panel part includes the micro pores and a second panel part includes first and second air inlet/outlet devices, and
wherein the first and second panel parts are formed as two separate parts.

14. A system of a control unit and a leading edge structure according to claim 2,
wherein the outlet valve is configured to be controlled to selectively operate in a flow control mode, where the outlet valve allows a first mass flow rate to pass that is configured to enable a predetermined flow control at the outer surface of the leading edge panel, and in a cleaning mode, where the outlet valve allows a second mass flow rate to pass that is configured to clean the micro pores by suction, and
wherein the control unit is configured to control the outlet valve to selectively operate in the flow control mode, where the outlet valve allows a first mass flow rate to pass that is configured to enable the predetermined flow control at the outer surface of the leading edge panel, and in the cleaning mode, where the outlet valve allows the second mass flow rate to pass that is configured to clean the micro pores by suction.

15. A vertical tail plane an aircraft, comprising
a vertical tail plane box having a first lateral panel with a first attachment portion and an opposite second lateral panel with a second attachment portion,
a leading edge structure according to claim 2,
wherein the first attachment end is attached to the first attachment portion, and
wherein the second attachment end is attached to the second attachment portion, so that the first side portion of the leading edge panel forms a continuous flow surface with the first lateral panel of the vertical tail plane box, and the second side portion of the leading edge panel forms a continuous flow surface with the second lateral panel of the vertical tail plane box.

16. The vertical tail plane according to claim 15,
wherein the outlet valve is configured to be controlled to selectively operate in a flow control mode, where the outlet valve allows a first mass flow rate to pass that is configured to enable a predetermined flow control at the outer surface of the leading edge panel, and in a cleaning mode, where the outlet valve allows a second mass flow rate to pass that is configured to clean the micro pores by suction,
wherein the control unit is configured to control the outlet valve to selectively operate in the flow control mode, where the outlet valve allows the first mass flow rate to pass that is configured to enable the predetermined flow control at the outer surface of the leading edge panel, and in a cleaning mode, where the outlet valve allows the second mass flow rate to pass that is configured to clean the micro pores by suction, and
wherein the first and second panel parts are arranged at the vertical tail plane box next to each other in the span direction such that the first panel part is arranged further outbound and the second panel part is arranged further inbound.

17. A vertical tail plane an aircraft, comprising
a vertical tail plane box having a first lateral panel with a first attachment portion and an opposite second lateral panel with a second attachment portion,
a system according to claim 14,
wherein the first attachment end is attached to the first attachment portion, and
wherein the second attachment end is attached to the second attachment portion, so that the first side portion of the leading edge panel forms a continuous flow surface with the first lateral panel of the vertical tail plane box, and the second side portion of the leading edge panel forms a continuous flow surface with the second lateral panel of the vertical tail plane box.

18. The vertical tail plane according to claim 17,
wherein the outlet valve is configured to be controlled to selectively operate in a flow control mode, where the outlet valve allows a first mass flow rate to pass that is configured to enable a predetermined flow control at the outer surface of the leading edge panel, and in a cleaning mode, where the outlet valve allows a second mass flow rate to pass that is configured to clean the micro pores by suction,
wherein the control unit is configured to control the outlet valve to selectively operate in a flow control mode, where the outlet valve allows the first mass flow rate to pass that is configured to enable the predetermined flow control at the outer surface of the leading edge panel, and in the cleaning mode, where the outlet valve allows the second mass flow rate to pass that is configured to clean the micro pores by suction, and
wherein the first and second panel parts are arranged at the vertical tail plane box next to each other in the span direction such that the first panel part is arranged further outbound and the second panel part is arranged further inbound.

19. An aircraft comprising a leading edge structure according to claim 1.

20. A method for operating a leading edge structure according to claim 2,
wherein the outlet valve is configured to be controlled to selectively operate in a flow control mode, where the outlet valve allows a first mass flow rate to pass that is configured to enable a predetermined flow control at the outer surface of the leading edge panel, and in a cleaning mode, where the outlet valve allows a second mass flow rate to pass that is configured to clean the micro pores by suction, and
wherein the outlet valve is controlled to selectively operate in the flow control mode, where the valve allows the first mass flow rate to pass that is configured to enable the predetermined flow control at the outer surface of the leading edge panel, and in a cleaning mode, where the outlet valve allows the second mass flow rate to pass that is configured to clean the micro pores by suction.
